(19) United States
(12) Patent Application Publication
(10) Pub. No.: US 2015/0046735 A1
(43) Pub. Date: Feb. 12, 2015

(54) PROCESSOR, NON-TRANSITORY COMPUTER READABLE MEDIUM, AND PROCESSING METHOD

(71) Applicant: FUJI XEROX CO., LTD., Tokyo (JP)

(72) Inventor: Masafumi ONO, Kanagawa (JP)

(73) Assignee: FUJI XEROX CO., LTD., Tokyo (JP)

(21) Appl. No.: 14/177,746

(22) Filed: Feb. 11, 2014

(30) Foreign Application Priority Data
Aug. 9, 2013 (JP) 2013-165978

(51) Int. Cl. G06F 1/32

(52) U.S. Cl. CPC G06F 1/3287
USPC 713/324

(57) ABSTRACT

A processor includes a communicating unit, a receiving unit, a processing unit, and a power-off controller. The receiving unit receives an operation from a user. The processing unit executes processing according to a processing request received by at least one of the communicating unit and the receiving unit. If a power-off request is received from a terminal by the communicating unit, the power-off controller stops the processing unit and disconnects a power supply when the operation received from the user by the receiving unit is not being processed and a condition determined in accordance with a processing mode of the power-off request is satisfied.

### CROSS-REFERENCE TO RELATED APPLICATIONS

This application is based on and claims priority under 35 USC 119 from Japanese Patent Application No. 2013-165978 filed Aug. 9, 2013.

### BACKGROUND

1. Technical Field

The present invention relates to a processor, a non-transitory computer readable medium, and a processing method.

2. Summary

According to an aspect of the invention, there is provided a processor including a communicating unit, a receiving unit, a processing unit, and a power-off controller. The receiving unit receives an operation from a user. The processing unit executes processing according to a processing request received by at least one of the communicating unit and the receiving unit. If a power-off request is received from a terminal by the communicating unit, the power-off controller stops the processing unit and disconnects a power supply when the operation received from the user by the receiving unit is not being processed and a condition determined in accordance with a processing mode of the power-off request is satisfied.

### BRIEF DESCRIPTION OF THE DRAWINGS

Exemplary embodiments of the present invention will be described in detail based on the following figures, wherein:

FIG. 1 is a system configuration diagram of an information processing system according to an exemplary embodiment of the present invention;

FIG. 2 is a configuration diagram of a part of hardware provided in an image forming apparatus;

FIG. 3 is a sequence diagram of remote power-off according to a first example;

FIG. 4 is a sequence diagram of remote power-off according to a second example;

FIG. 5 is a sequence diagram of remote power-off according to a third example;

FIG. 6 is a sequence diagram of remote power-off according to a fourth example;

FIG. 7 is a diagram illustrating an example of a printer administration screen;

FIG. 8 is a diagram illustrating an example of an administrator authentication screen;

FIG. 9 is a diagram illustrating an example of a forced remote power-off confirmation screen; and

FIG. 10 is a diagram illustrating an example of a printer administration screen.

### DETAILED DESCRIPTION

With reference to the drawings, exemplary embodiments for implementing the present invention (hereinafter referred to as exemplary embodiments) will be described below.

### 1. System Configuration

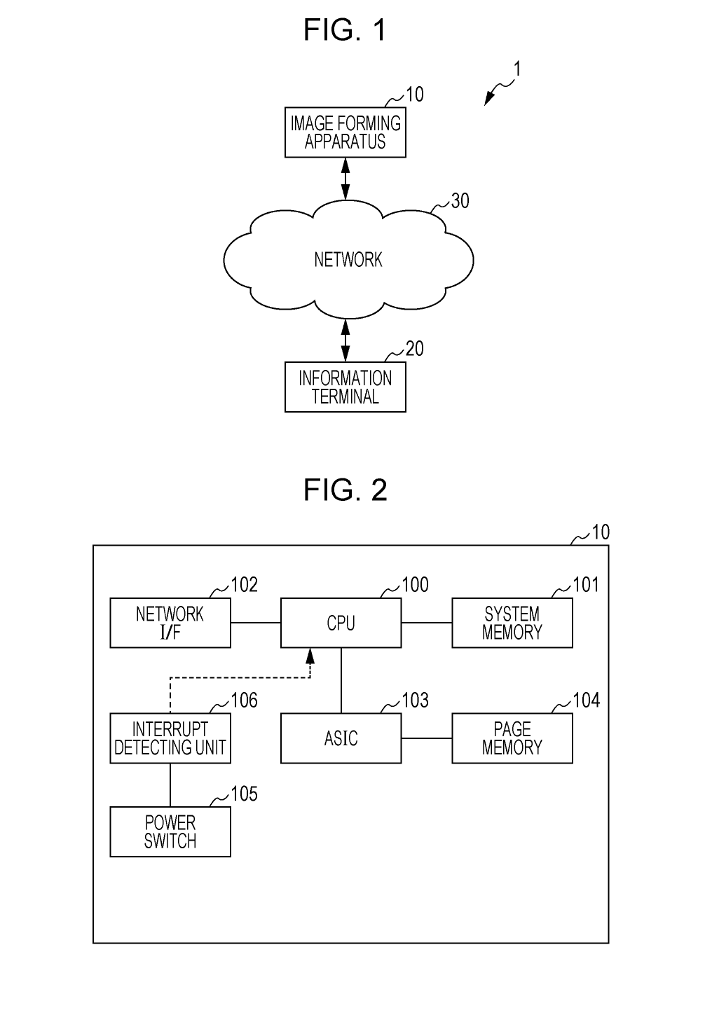

FIG. 1 illustrates a system configuration diagram of an information processing system 1 according to an exemplary embodiment of the present invention. As illustrated in FIG. 1, the information processing system 1 includes an image forming apparatus 10 and an information terminal 20, which are data-communicably connected to each other via a network 30. The network 30 may be configured to include either or both of a local area network and a wide area network.

In the present exemplary embodiment, the image forming apparatus 10 may be a multifunction printer having a communication function, an image formation function, a scan function, a copy function, and so forth. Further, the image forming apparatus 10 may include an operation receiving unit such as an operation panel and execute functions such as image formation, scan, and copy in accordance with an operation received from a user by the operation receiving unit.

The information terminal 20 may be a computer operated by a user, and may be connected to the image forming apparatus 10 via the network 30 to administrate the image forming apparatus 10 and transmit a print job to the image forming apparatus 10 to cause the image forming apparatus 10 to execute print processing.

The image forming apparatus 10 according to the present exemplary embodiment has a function of executing power-off processing on the basis of the status of the image forming apparatus 10 in accordance with a power-off request from the information terminal 20 connected to the image forming apparatus 10 via the network 30.

### 2. Hardware Configuration

FIG. 2 illustrates a configuration diagram of a part of hardware provided in the image forming apparatus 10. As illustrated in FIG. 2, the image forming apparatus 10 includes a central processing unit (CPU) 100, a system memory 101, a network interface (I/F) 102, an application specific integrated circuit (ASIC) 103, a page memory 104, a power switch 105, and an interrupt detecting unit 106.

The CPU 100 is a central processing unit that controls respective units of the image forming apparatus 10, and executes processing on the basis of programs and data stored in the system memory 101, for example.

The system memory 101 is a memory that stores programs and data for controlling the image forming apparatus 10.

The network interface 102 is realized by a wireless or wired network interface card, for example, and serves as a communication interface for communicating data with another device connected to the network 30.

The ASIC 103 is an integrated circuit that realizes specific functions provided to the image forming apparatus 10. For example, the ASIC 103 may be an integrated circuit that realizes the image formation function, the scan function, and the copy function.

The page memory 104 is a memory used by the ASIC 103, and may be used to store image data of each page to be printed by a print job and image data of a scanned document, for example.

The power switch 105 is a switch that switches between ON and OFF of the image forming apparatus 10. The power switch 105 is provided separately from a major power switch that switches between ON and OFF of power feed to the image forming apparatus 10, and serves as a sub-power switch for controlling ON and OFF of the image forming apparatus 10 in a software manner. Herein, the status of the power switch 105 per se is not specified. If the power switch 105 is pressed in the OFF state of the image forming apparatus 10, processing of starting up the image forming apparatus 10 to the ON state is executed. Further, if the power switch 105 is pressed in the ON state of the image forming apparatus 10, processing of shutting down the image forming apparatus 10 to the OFF state is executed.

The interrupt detecting unit 106 detects the pressing of the power switch 105, and notifies the CPU 100 of the detection to cause the CPU 100 to execute interrupt processing relating to powering on or off.

Herein, if the software power-off is executed by the power switch 105, the CPU 100, the network interface 102, and the ASIC 103 shift to the OFF state in which power feed is stopped, and the system memory 101 and the page memory 104 shift to a self-refresh mode or the OFF state. Further, the interrupt detecting unit 106 shifts to a power saving mode in which power supply is reduced as compared with a normal state. If the hardware power-off is executed by the major power switch, all hardware components shift to the OFF state in which power feed is stopped.

Further, upon detecting the pressing of the power switch 105 in the software power-off state, the interrupt detecting unit 106 starts up a power supply circuit that supplies power to the CPU 100 and so forth, to thereby start start-up processing of the image forming apparatus 10.

### 3. Description of Details of Processing

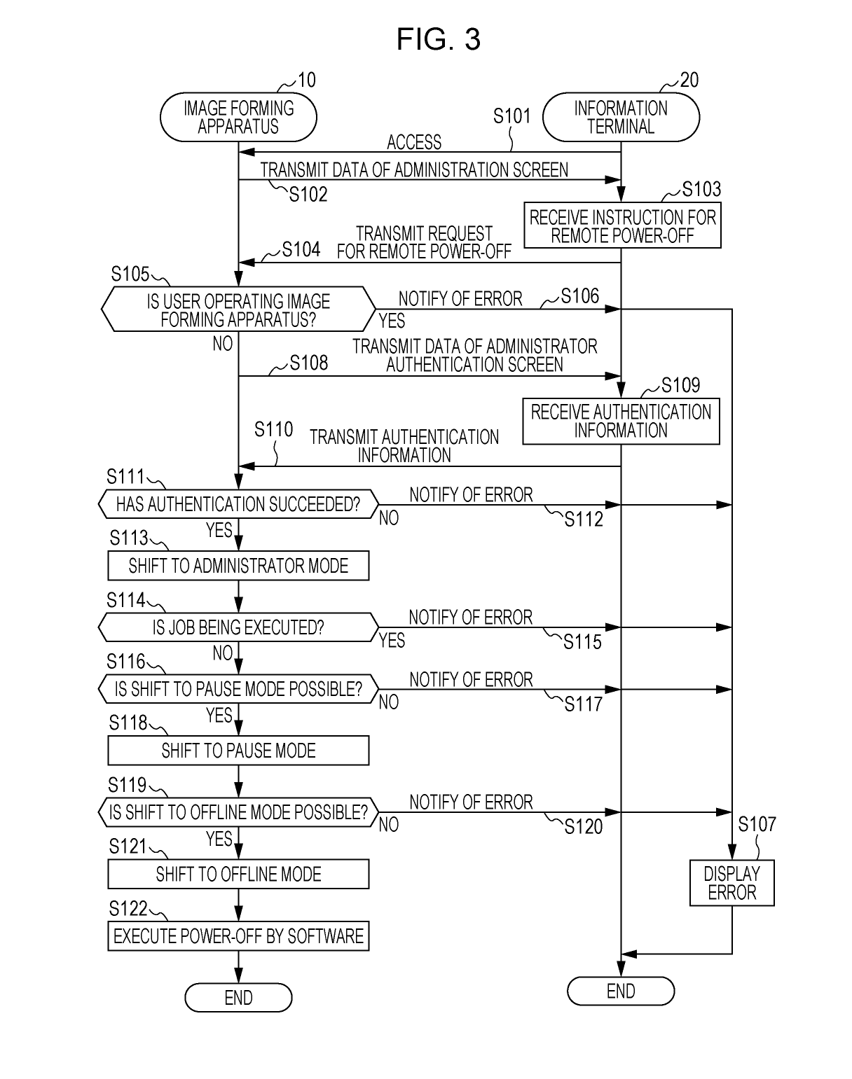

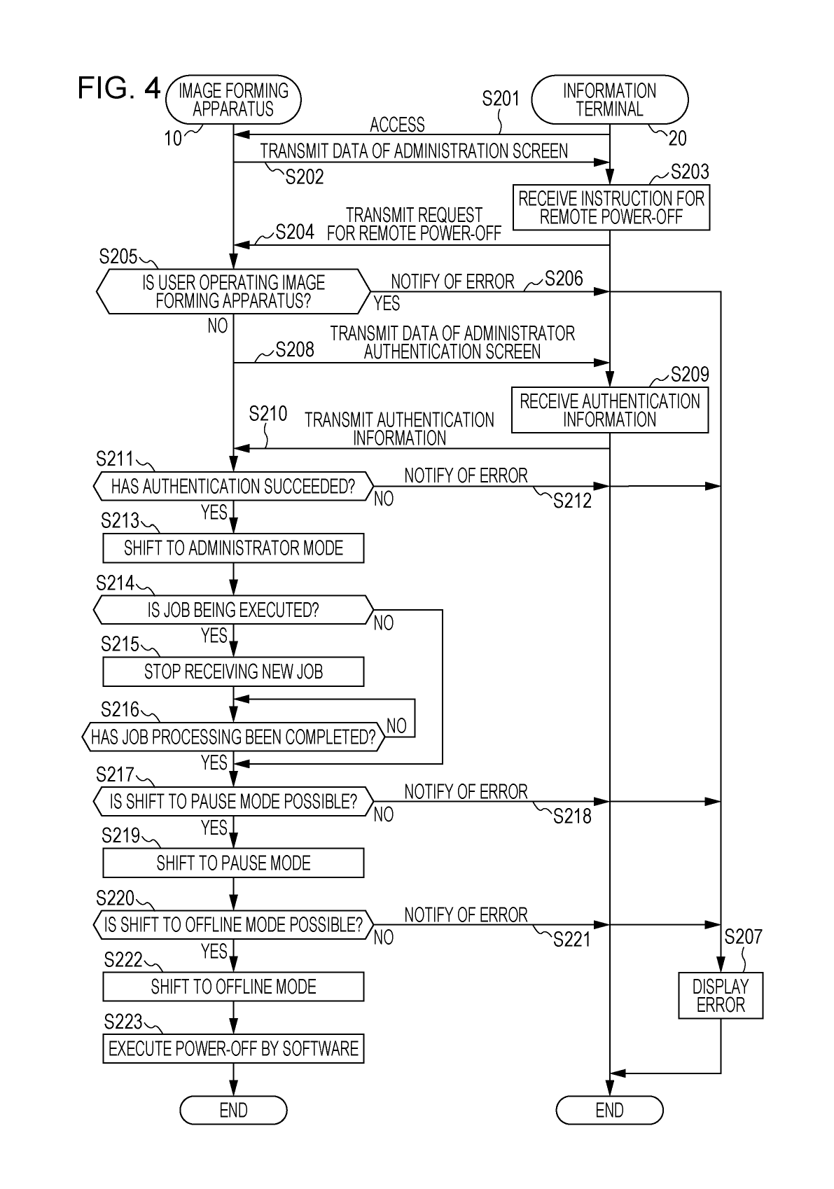

With reference to FIGS. 3 to 10, description will now be given of details of processing relating to remote power-off of turning off the power supply of the image forming apparatus 10 in accordance with a request from the information terminal 20 in the information processing system 1. The following description will be given of four patterns of remote power-off processing as first to fourth examples.

### 3-1. First Example

Remote power-off processing according to the first example will first be described. FIG. 3 illustrates a sequence diagram of the remote power-off according to the first example.

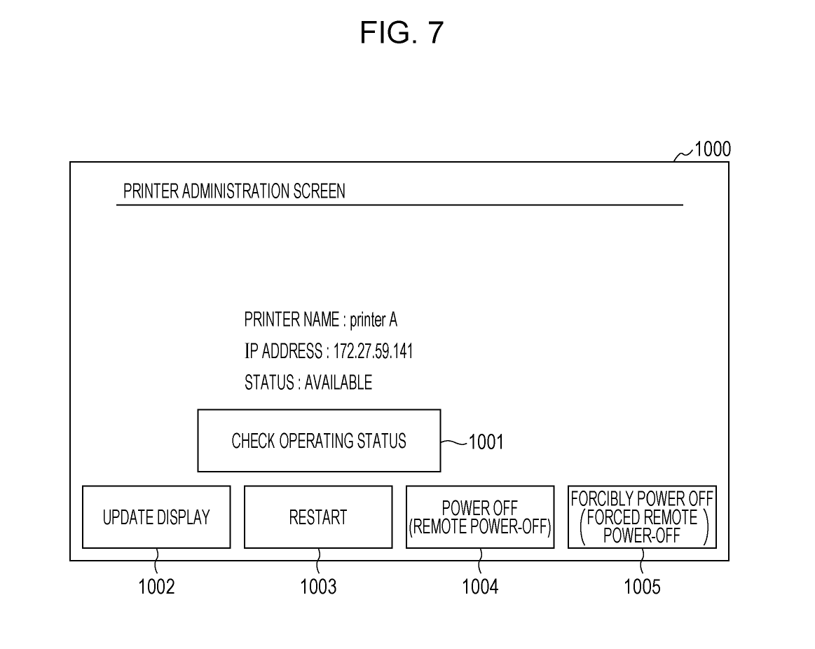

As illustrated in FIG. 3, when the information terminal 20 accesses the image forming apparatus 10 on the basis of an operation performed by a user, for example (step S101), the image forming apparatus 10 transmits display data of a printer administration screen 1000 to the information terminal 20 (step S102). On the basis of the display data of the printer administration screen 1000 received from the image forming apparatus 10, the information terminal 20 displays the printer administration screen 1000 illustrated in FIG. 7, for example.

As illustrated in FIG. 7, the printer administration screen 1000 displays the name of the printer, address information (internet protocol (IP) address) of the printer, and the status of the printer. Further, if a “check operating status” button 1001 displayed on the printer administration screen 1000 is pressed, information of a job being executed by the image forming apparatus 10 and a job received by the image forming apparatus 10, for example, is displayed. Further, if an “update display” button 1002 on the printer administration screen 1000 is pressed, a request for updating the display of the printer administration screen 1000 is transmitted to the image forming apparatus 10. Further, if a “restart” button 1003 is pressed, a request for restart processing is transmitted to the image forming apparatus 10. Further, if a “power off (remote power-off)” button 1004 on the printer administration screen 1000 is pressed, a request for normal remote power-off processing is transmitted to the image forming apparatus 10. Further, if a “forcibly power off (forced remote power-off)” button 1005 on the printer administration screen 1000 is pressed, a request for forced remote power-off processing is transmitted to the image forming apparatus 10.

In the first example, if the information terminal 20 receives an instruction for the remote power-off from the user with the “power off (remote power-off)” button 1004 pressed on the printer administration screen 1000 (step S103), the information terminal 20 transmits a request for the remote power-off to the image forming apparatus 10 (step S104).

If the user is operating the image forming apparatus 10 (YES at step S105), the image forming apparatus 10 notifies the information terminal 20 of an error (step S106). The information terminal 20 displays the error on the basis of the notified error (step S107), and completes the processing.

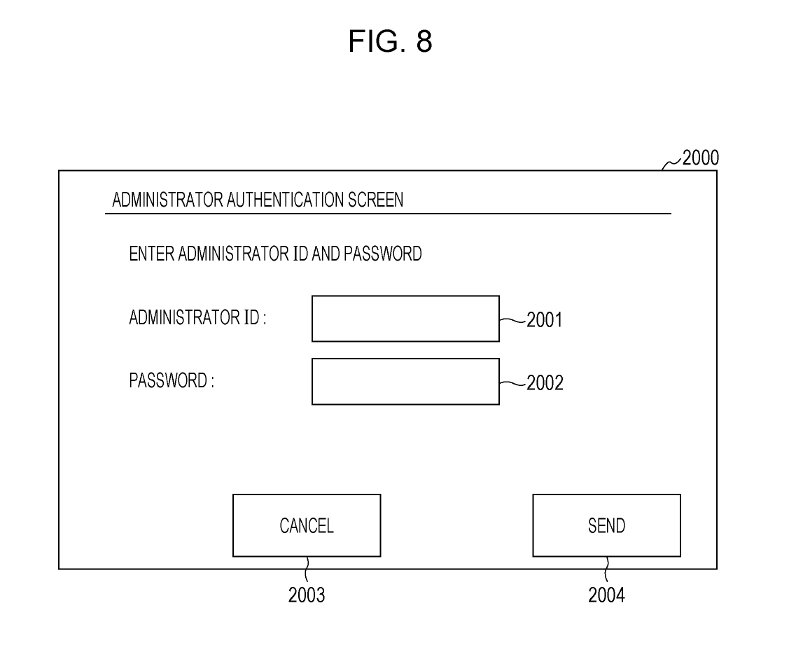

Further, if the user is not operating the image forming apparatus 10 (NO at step S105), the image forming apparatus 10 transmits display data for displaying an administrator authentication screen 2000 to the information terminal 20 (step S108). On the basis of the display data of the administrator authentication screen 2000 received from the image forming apparatus 10, the information terminal 20 displays the administrator authentication screen 2000 illustrated in FIG. 8, for example.

As illustrated in FIG. 8, the administrator authentication screen 2000 is provided with an administrator identifier (ID) input field 2001, a password input field 2002, a “cancel” button 2003, and a “send” button 2004. Herein, the information terminal 20 receives authentication information (information input to the administrator ID input field 2001 and the password input field 2002) on the administrator authentication screen 2000 (step S109). Then, if the “send” button 2004 is pressed, the information terminal 20 transmits the received authentication information to the image forming apparatus 10 (step S110).

If authentication based on the authentication information received from the information terminal 20 fails (i.e., if the pair of the administrator ID and the password does not match the corresponding stored data) (NO at step S111), the image forming apparatus 10 notifies the information terminal 20 of an authentication error (step S112). The information terminal 20 displays the error on the basis of the notified error (step S107), and completes the processing.

If the authentication based on the authentication information received from the information terminal 20 succeeds (i.e., if the pair of the administrator ID and the password matches the corresponding stored data) (YES at step S111), the image forming apparatus 10 shifts to an administrator mode for executing the processing by authority of the administrator (step S113).

Then, if the image forming apparatus 10 is executing a job (or has an unprocessed job) (YES at step S114), the image forming apparatus 10 cancels the administrator mode, to which the image forming apparatus 10 has shifted, and thereafter notifies the information terminal 20 of an error (step S115). The information terminal 20 displays the error on the basis of the notified error (step S107), and completes the processing.

If the image forming apparatus 10 is not executing a job (and has no unprocessed job) (NO at step S114), the image forming apparatus 10 proceeds to step S116.

At step S116, the image forming apparatus 10 determines whether or not the shift to a pause mode for stopping job execution is possible (step S116). If any failure occurs in the processing being executed, for example, the image forming apparatus 10 may determine that the shift to the pause mode is not possible. Further, if the shift to the pause mode is not possible (NO at step S116), the image forming apparatus 10 cancels the administrator mode, to which the image forming apparatus 10 has shifted, and thereafter notifies the information terminal 20 of an error (step S117). The information terminal 20 displays the error on the basis of the notified error (step S107), and completes the processing.

If the shift to the pause mode is possible (YES at step S116), the image forming apparatus 10 shifts to the pause mode (step S118), and proceeds to step S119.

At step S119, the image forming apparatus 10 determines whether or not the shift to an offline mode for stopping the reception of a new job is possible (step S119). Then, if the shift to the offline mode is not possible (NO at step S119), the image forming apparatus 10 cancels the pause mode, to which the image forming apparatus 10 has shifted, and further cancels the administrator mode. Thereafter, the image forming apparatus 10 notifies the information terminal 20 of an error (step S120). The information terminal 20 displays the error on the basis of the notified error (step S107), and completes the processing.

If the shift to the offline mode is possible (YES at step S119), the image forming apparatus 10 shifts to the offline mode (step S121), and executes the power-off processing by software (step S122). In the image forming apparatus 10, therefore, the CPU 100, the network interface 102, and the ASIC 103 shift to the OFF state in which power feed is stopped, and the system memory 101 and the page memory 104 shift to the self-refresh mode or the OFF state. Further, the interrupt detecting unit 106 shifts to the power saving mode in which power supply is reduced as compared with a normal state.

The remote power-off processing according to the first example has been described above. In the remote power-off according to the first example, it is possible to shut down the system, if the system is ready to be safely shut down at the time of receipt of the request for the remote power-off.

### 3-2. Second Example

Remote power-off processing according to the second example will now be described. FIG. 4 illustrates a sequence diagram of the remote power-off according to the second example.

As illustrated in FIG. 4, when the information terminal 20 accesses the image forming apparatus 10 on the basis of an operation performed by a user, for example (step S201), the image forming apparatus 10 transmits the display data of the printer administration screen 1000 to the information terminal 20 (step S202). On the basis of the display data of the printer administration screen 1000 received from the image forming apparatus 10, the information terminal 20 displays the printer administration screen 1000 illustrated in FIG. 7, for example.

In the second example, if the information terminal 20 receives an instruction for the remote power-off from the user with the “power off (remote power-off)” button 1004 pressed on the printer administration screen 1000 (step S203), the information terminal 20 transmits a request for the remote power-off to the image forming apparatus 10 (step S204).

If the user is operating the image forming apparatus 10 (YES at step S205), the image forming apparatus 10 notifies the information terminal 20 of an error (step S206). The information terminal 20 displays the error on the basis of the notified error (step S207), and completes the processing.

Further, if the user is not operating the image forming apparatus 10 (NO at step S205), the image forming apparatus 10 transmits the display data for displaying the administrator authentication screen 2000 to the information terminal 20 (step S208). On the basis of the display data of the administrator authentication screen 2000 received from the image forming apparatus 10, the information terminal 20 displays the administrator authentication screen 2000 illustrated in FIG. 8, for example.

The information terminal 20 receives authentication information (information input to the administrator ID input field 2001 and the password input field 2002) on the administrator authentication screen 2000 (step S209). Then, if the “send” button 2004 is pressed, the information terminal 20 transmits the received authentication information to the image forming apparatus 10 (step S210).

If authentication based on the authentication information received from the information terminal 20 fails (i.e., if the pair of the administrator ID and the password does not match the corresponding stored data) (NO at step S211), the image forming apparatus 10 notifies the information terminal 20 of an authentication error (step S212). The information terminal 20 displays the error on the basis of the notified error (step S207), and completes the processing.

If the authentication based on the authentication information received from the information terminal 20 succeeds (i.e., if the pair of the administrator ID and the password matches the corresponding stored data) (YES at step S211), the image forming apparatus 10 shifts to the administrator mode for executing the processing by authority of the administrator (step S213).

Then, if the image forming apparatus 10 is executing a job (or has an unprocessed job) (YES at step S214), the image forming apparatus 10 stops receiving a new job (step S215), and determines whether or not the processing of the currently received job has been completed (step S216). Herein, if the processing of the currently received job has not been completed (NO at step S216), the image forming apparatus 10 waits for the completion of the processing. If the processing of the currently received job has been completed (YES at step S216), the image forming apparatus 10 proceeds to step S217.

The image forming apparatus 10 also proceeds to step S217 if the image forming apparatus 10 is not executing a job (and has no unprocessed job) (NO at step S214).

At step S217, the image forming apparatus 10 determines whether or not the shift to the pause mode for stopping job execution is possible (step S217). Then, if the shift to the pause mode is not possible (NO at step S217), the image forming apparatus 10 cancels the administrator mode, to which the image forming apparatus 10 has shifted, and thereafter notifies the information terminal 20 of an error (step S218). The information terminal 20 displays the error on the basis of the notified error (step S207), and completes the processing.

If the shift to the pause mode is possible (YES at step S217), the image forming apparatus 10 shifts to the pause mode (step S219), and proceeds to step S220.

At step S220, the image forming apparatus 10 determines whether or not the shift to the offline mode for stopping the reception of a new job is possible (step S220). Then, if the shift to the offline mode is not possible (NO at step S220), the image forming apparatus 10 cancels the pause mode, to which the image forming apparatus 10 has shifted, and further cancels the administrator mode. Thereafter, the image forming apparatus 10 notifies the information terminal 20 of an error (step S221). The information terminal 20 displays the error on the basis of the notified error (step S207), and completes the processing.

If the shift to the offline mode is possible (YES at step S220), the image forming apparatus 10 shifts to the offline mode (step S222), and executes the power-off processing by software (step S223). In the image forming apparatus 10, therefore, the CPU 100, the network interface 102, and the ASIC 103 shift to the OFF state in which power feed is stopped, and the system memory 101 and the page memory 104 shift to the self-refresh mode or the OFF state. Further, the interrupt detecting unit 106 shifts to the power saving mode in which power supply is reduced as compared with a normal state.

The remote power-off processing according to the second example has been described above. In the remote power-off according to the second example, even if a job to be processed is left at the time of receipt of the request for the remote power-off, it is possible to shut down the system after waiting until the system is ready to be safely shut down.

### 3-3. Third Example

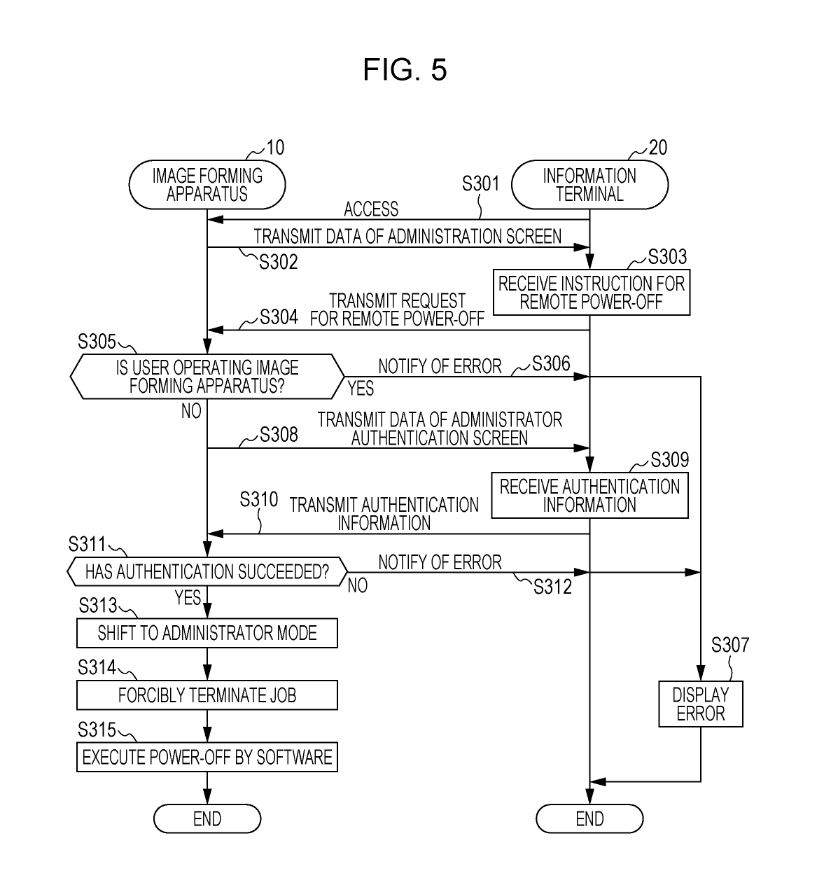

Remote power-off processing according to the third example will now be described. FIG. 5 illustrates a sequence diagram of the remote power-off (forced remote power-off) according to the third example.

As illustrated in FIG. 5, when the information terminal 20 accesses the image forming apparatus 10 on the basis of an operation performed by a user, for example (step S301), the image forming apparatus 10 transmits the display data of the printer administration screen 1000 to the information terminal 20 (step S302). On the basis of the display data of the printer administration screen 1000 received from the image forming apparatus 10, the information terminal 20 displays the printer administration screen 1000 illustrated in FIG. 7, for example.

In the third example, if the information terminal 20 receives an instruction for the forced remote power-off from the user with the “forcibly power off (forced remote power-off)” button 1005 pressed on the printer administration screen 1000 (step S303), the information terminal 20 transmits a request for the forced remote power-off to the image forming apparatus 10 (step S304).

If the user is operating the image forming apparatus 10 (YES at step S305), the image forming apparatus 10 notifies the information terminal 20 of an error (step S306). The information terminal 20 displays the error on the basis of the notified error (step S307), and completes the processing.

Further, if the user is not operating the image forming apparatus 10 (NO at step S305), the image forming apparatus 10 transmits the display data for displaying the administrator authentication screen 2000 to the information terminal 20 (step S308). On the basis of the display data of the administrator authentication screen 2000 received from the image forming apparatus 10, the information terminal 20 displays the administrator authentication screen 2000 illustrated in FIG. 8, for example.

The information terminal 20 receives authentication information (information input to the administrator ID input field 2001 and the password input field 2002) on the administrator authentication screen 2000 (step S309). Then, if the “send” button 2004 is pressed, the information terminal 20 transmits the received authentication information to the image forming apparatus 10 (step S310).

If authentication based on the authentication information received from the information terminal 20 fails (i.e., if the pair of the administrator ID and the password does not match the corresponding stored data) (NO at step S311), the image forming apparatus 10 notifies the information terminal 20 of an authentication error (step S312). The information terminal 20 displays the error on the basis of the notified error (step S307), and completes the processing.

If the authentication based on the authentication information received from the information terminal 20 succeeds (i.e., if the pair of the administrator ID and the password matches the corresponding stored data) (YES at step S311), the image forming apparatus 10 shifts to the administrator mode for executing the processing by authority of the administrator (step S313).

Then, even if the image forming apparatus 10 is executing a job, the image forming apparatus 10 forcibly terminates the job being executed (step S314). Then, if the image forming apparatus 10 is ready to be powered off, the image forming apparatus 10 executes the power-off processing by software (step S315). In the image forming apparatus 10, therefore, the CPU 100, the network interface 102, and the ASIC 103 shift to the OFF state in which power feed is stopped, and the system memory 101 and the page memory 104 shift to the self-refresh mode or the OFF state. Further, the interrupt detecting unit 106 shifts to the power saving mode in which power supply is reduced as compared with a normal state.

The remote power-off processing according to the third example has been described above. In the remote power-off according to the third example, it is possible to promptly shut down the system even if a job to be processed is left at the time of receipt of the request for the remote power-off.

### 3-4. Fourth Example

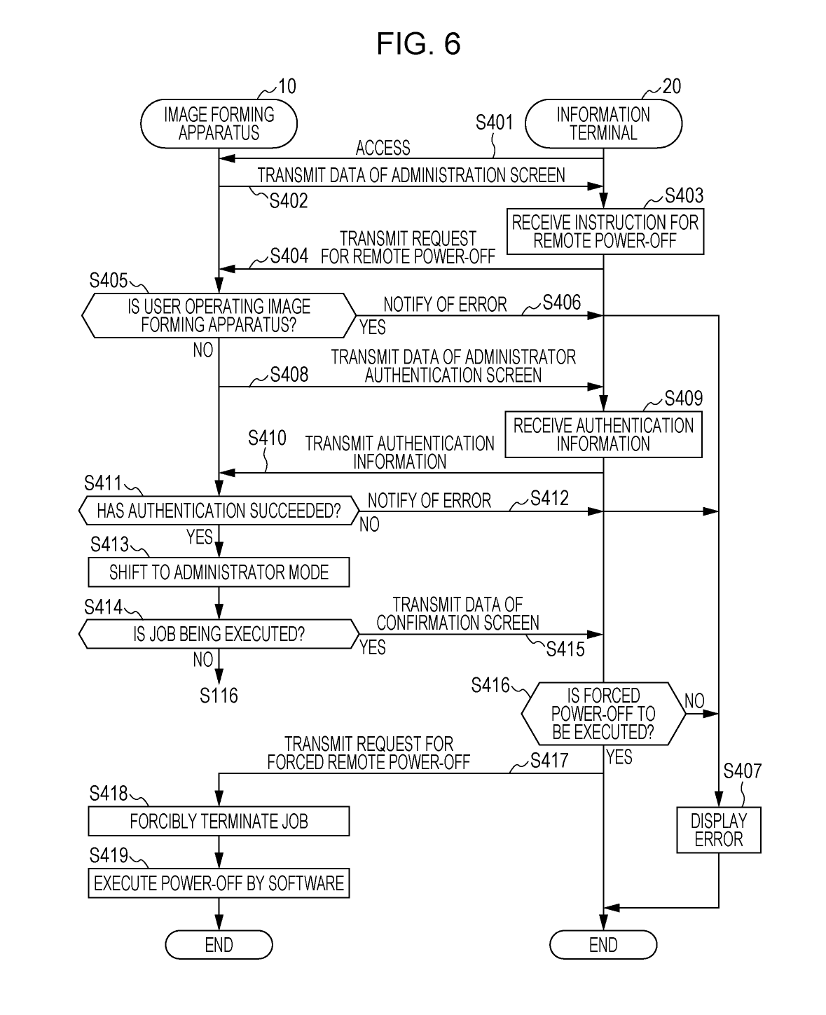

Remote power-off processing according to the fourth example will now be described. FIG. 6 illustrates a sequence diagram of the remote power-off according to the fourth example.

As illustrated in FIG. 6, when the information terminal 20 accesses the image forming apparatus 10 on the basis of an operation performed by a user, for example (step S401), the image forming apparatus 10 transmits the display data of the printer administration screen 1000 to the information terminal 20 (step S402). On the basis of the display data of the printer administration screen 1000 received from the image forming apparatus 10, the information terminal 20 displays the printer administration screen 1000 illustrated in FIG. 7, for example.

In the fourth example, if the information terminal 20 receives an instruction for the remote power-off from the user with the “power off (remote power-off)” button 1004 pressed on the printer administration screen 1000 (step S403), the information terminal 20 transmits a request for the remote power-off to the image forming apparatus 10 (step S404).

If the user is operating the image forming apparatus 10 (YES at step S405), the image forming apparatus 10 notifies the information terminal 20 of an error (step S406). The information terminal 20 displays the error on the basis of the notified error (step S407), and completes the processing.

Further, if the user is not operating the image forming apparatus 10 (NO at step S405), the image forming apparatus 10 transmits the display data for displaying the administrator authentication screen 2000 to the information terminal 20 (step S408). On the basis of the display data of the administrator authentication screen 2000 received from the image forming apparatus 10, the information terminal 20 displays the administrator authentication screen 2000 illustrated in FIG. 8, for example.

The information terminal 20 receives authentication information (information input to the administrator ID input field 2001 and the password input field 2002) on the administrator authentication screen 2000 (step S409). Then, if the “send” button 2004 is pressed, the information terminal 20 transmits the received authentication information to the image forming apparatus 10 (step S410).

If authentication based on the authentication information received from the information terminal 20 fails (i.e., if the pair of the administrator ID and the password does not match the corresponding stored data) (NO at step S411), the image forming apparatus 10 notifies the information terminal 20 of an authentication error (step S412). The information terminal 20 displays the error on the basis of the notified error (step S407), and completes the processing.

If the authentication based on the authentication information received from the information terminal 20 succeeds (i.e., if the pair of the administrator ID and the password matches the corresponding stored data) (YES at step S411), the image forming apparatus 10 shifts to the administrator mode for executing the processing by authority of the administrator (step S413).

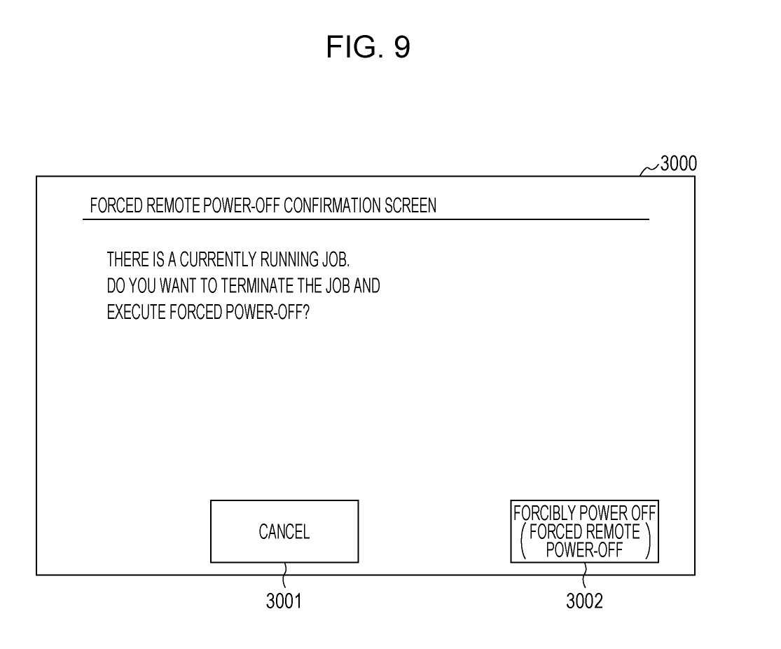

Then, if the image forming apparatus 10 is executing a job (or has an unprocessed job) (YES at step S414), the image forming apparatus 10 transmits display data for displaying a forced remote power-off confirmation screen to the information terminal 20 (step S415). On the basis of the display data for displaying the forced remote power-off confirmation screen received from the image forming apparatus 10, the information terminal 20 displays a forced remote power-off confirmation screen 3000 illustrated in FIG. 9, for example.

As illustrated in FIG. 9, the forced remote power-off confirmation screen 3000 is provided with a “cancel” button 3001 and a “forcibly power off (forced remote power-off)” button 3002. Herein, if the “forcibly power off (forced remote power-off)” button 3002 is pressed on the forced remote power-off confirmation screen 3000 (YES at step S416), the information terminal 20 transmits a request for the forced remote power-off to the image forming apparatus 10 (step S417).

Even if the image forming apparatus 10 is executing a job, the image forming apparatus 10 forcibly terminates the job being executed upon receipt of the request for the forced remote power-off from the information terminal 20 (step S418). Then, if the image forming apparatus 10 is ready to be powered off, the image forming apparatus 10 executes the power-off processing by software (step S419). In the image forming apparatus 10, therefore, the CPU 100, the network interface 102, and the ASIC 103 shift to the OFF state in which power feed is stopped, and the system memory 101 and the page memory 104 shift to the self-refresh mode or the OFF state. Further, the interrupt detecting unit 106 shifts to the power saving mode in which power supply is reduced as compared with a normal state.

Further, if the image forming apparatus 10 is not executing a job (and has no unprocessed job) at step S414 (NO at step S414), the image forming apparatus 10 proceeds to step S116 in FIG. 3. Since the processes of step S116 and the subsequent steps in FIG. 3 have already been described, the description thereof will be omitted here.

The remote power-off processing according to the fourth example has been described above. In the remote power-off according to the fourth example, if there is no job to be processed at the time of receipt of the request for the remote power-off, it is possible to safely shut down the system. Further, even if a job to be processed is left at the time of receipt of the request for the remote power-off, it is possible to promptly shut down the system.

The present invention is not limited to the above-described exemplary embodiment. In the above-described exemplary embodiment, the description has been given of the example in which the information terminal 20 transmits the request for the remote power-off to the single image forming apparatus 10. However, the information terminal 20 may administer plural image forming apparatuses 10 and transmit the request for the remote power-off in batch to the plural image forming apparatuses 10.

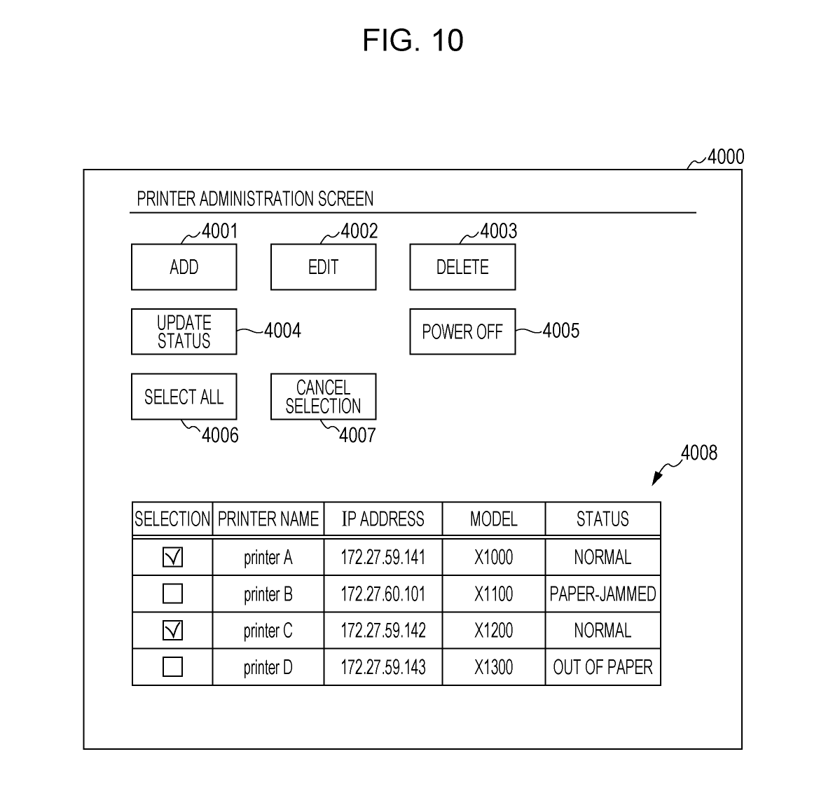

FIG. 10 illustrates an example of an administration screen (printer administration screen 4000) for the case in which the information terminal 20 administers plural image forming apparatuses 10. As illustrated in FIG. 10, the printer administration screen 4000 includes an “add” button 4001, an “edit” button 4002, a “delete” button 4003, an “update status” button 4004, a “power off” button 4005, a “select all” button 4006, a “cancel selection” button 4007, and a printer status display table 4008. The “add” button 4001 is for adding a printer to be administered to the printer administration screen 4000. The “edit” button 4002 is for editing the information of any of the administered printers. The “delete” button 4003 is for deleting any of the administered printers. The “update status” button 4004 is for updating the display of the status information of any of the administered printers. The “power off” button 4005 is for transmitting the request for the remote power-off to any selected printer. The “select all” button 4006 is for selecting all of the administered printers. The “cancel selection” button 4007 is for cancelling the selection of the selected printer. The printer status display table 4008 displays a list of statuses of the administered printers.

The printer status display table 4008 displays selection checkboxes, printer names, IP addresses, printer models, and printer statuses related to one another. If the “power off” button 4005 is pressed with the selection checkboxes for one or more administered printers checked, the information terminal 20 may transmit the request for the remote power-off to each of the printers corresponding to the checked selection checkboxes. The above-described processing is, of course, applicable to the remote power-off processing of each of the printers.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A processor comprising:
a communicating unit;
a receiving unit that receives an operation from a user;
a processing unit that executes processing according to a processing request received by at least one of the communicating unit and the receiving unit; and
a power-off controller that, if a power-off request is received from a terminal by the communicating unit, stops the processing unit and disconnects a power supply when the operation received from the user by the receiving unit is not being processed and a condition determined in accordance with a processing mode of the power-off request is satisfied.

2. The processor according to claim 1, wherein, if the power-off request in a normal disconnection mode is received from the terminal by the communicating unit, the power-off controller stops the processing unit and disconnects the power supply when the operation received from the user by the receiving unit is not being processed, the processing according to the processing request received by the communicating unit is not being executed, and the reception of a new processing request is stoppable by the communicating unit and the receiving unit.

3. The processor according to claim 1, wherein, if the power-off request in a normal disconnection mode is received from the terminal by the communicating unit during the execution of the processing according to the processing request received by the communicating unit, the power-off controller waits for the completion of the processing being executed, and thereafter stops the processing unit and disconnects the power supply when the operation received from the user by the receiving unit is not being processed and the reception of a new processing request is stoppable by the communicating unit and the receiving unit.

4. The processor according to claim 1, wherein, if the power-off request in a forced disconnection mode is received from the terminal by the communicating unit, the power-off controller forcibly stops the processing unit and disconnects the power supply when the operation received from the user by the receiving unit is not being processed.

5. The processor according to claim 1, further comprising:
an inquiring unit that, if the power-off request in a normal disconnection mode is received from the terminal by the communicating unit during the processing of the operation received from the user by the receiving unit, inquires of the terminal whether or not to disconnect the power supply in a forced disconnection mode,
wherein, if the power-off request in the forced disconnection mode is received from the terminal by the communicating unit in accordance with the inquiry, the power-off controller forcibly stops the processing unit and disconnects the power supply when the operation received from the user by the receiving unit is not being processed.

6. The processor according to claim 1, wherein, if administrator authentication information acquired from the terminal is not appropriate, the power-off controller does not execute the processing of disconnecting the power supply.

7. The processor according to claim 2, wherein, if administrator authentication information acquired from the terminal is not appropriate, the power-off controller does not execute the processing of disconnecting the power supply.

8. The processor according to claim 3, wherein, if administrator authentication information acquired from the terminal is not appropriate, the power-off controller does not execute the processing of disconnecting the power supply.

9. The processor according to claim 4, wherein, if administrator authentication information acquired from the terminal is not appropriate, the power-off controller does not execute the processing of disconnecting the power supply.

10. The processor according to claim 5, wherein, if administrator authentication information acquired from the terminal is not appropriate, the power-off controller does not execute the processing of disconnecting the power supply.

11. A non-transitory computer readable medium storing a program causing a computer, which includes a communicating unit, a receiving unit that receives an operation from a user, and a processing unit that executes processing according to a processing request received by at least one of the communicating unit and the receiving unit, to execute a process for processing, the process comprising:
if a power-off request is received from a terminal by the communicating unit, stopping the processing unit and disconnecting a power supply when the operation received from the user is not being processed and a condition determined in accordance with a processing mode of the power-off request is satisfied.

12. A processing method comprising:
receiving an operation from a user;
causing a processing unit to execute processing according to a received processing request; and
if a power-off request is received from a terminal, stopping the processing unit and disconnecting a power supply when the operation received from the user is not being processed and a condition determined in accordance with a processing mode of the power-off request is satisfied.
